(19) United States
(12) Patent Application Publication
(10) Pub. No.: US 2025/0271070 A1
(43) Pub. Date: Aug. 28, 2025

(54) SWING CHECK VALVE

(71) Applicant: DeZURIK, Inc., Sartell, MN (US)

(72) Inventors: Daniel Schoborg, Oak Park, MN (US); Jeffrey Diehl, Saint Cloud, MN (US); Leo Thomas Wehseler, Pierz, MN (US)

(21) Appl. No.: 19/061,599

(22) Filed: Feb. 24, 2025

Related U.S. Application Data
(60) Provisional application No. 63/557,477, filed on Feb. 24, 2024.

(51) Int. Cl. F16K 15/03

(52) U.S. Cl. CPC F16K 15/034

(57) ABSTRACT

A swing check valve is disclosed, the swing check valve comprising a housing; a disc; and a sealing arrangement between the housing and disc. The sealing arrangement comprises a flexible disc seat; and a metallic body seat. The metallic body seat comprises an engagement surface for engaging the flexible disc seat, the engagement surface includes a raised portion for engaging the flexible disc. In an embodiment the metallic body seat comprises an engagement surface for engaging the disc seat, the engagement surface comprising a first portion for engaging a flexible elastomeric portion of the disc seat and a second portion for engaging a metallic portion of the disc seat after compressing the flexible elastomeric portion.

This application is a non-provisional application claiming priority to U.S. Provisional Application No. 63/557,477, filed Feb. 24, 2024, and the entire contents are incorporated herein by reference.

### FIELD OF THE INVENTION

The present application is directed to valves, in particular to swing check valves for use in fluid handling systems.

### BACKGROUND OF THE INVENTION

A swing check valve is a type of check valve used in piping systems to prevent backflow. It operates by allowing flow in only one direction while automatically blocking the flow in the opposite direction. The valve consists of a disc that swings on a hinge or pivot inside the valve body.

Swing check valves work as follows: For flow direction, when fluid flows in the desired direction (forward flow), the pressure of the fluid pushes disc open, allowing the fluid to pass through the valve freely. If there is a reversal in flow direction (backflow), the disc swings back to its closed position, preventing the fluid from flowing backward. This action occurs due to gravity or the force of the flowing fluid itself, as well as an assist device in some situations, which pushes the disc against the seat of the valve, creating a seal.

Swing check valves are commonly used in various applications, including water supply systems, wastewater systems, and industrial processes. They offer advantages such as low pressure drop, minimal turbulence, and reliable operation. However, it's important to consider factors such as the material of construction, valve size, and flow conditions to ensure proper selection and installation for specific requirements. In addition, there remains a need for improved seals between the disc and seat of the valve.

### SUMMARY OF THE INVENTION

The present application is directed to a swing check valve, the swing check valve having a housing, a disc, and a sealing arrangement between the housing and disc. The sealing arrangement includes a flexible disc seat, and a metallic body seat, wherein the metallic body seat includes an engagement surface for engaging the flexible disc seat. The engagement surface can include a raised portion for engaging the flexible disc seat in certain embodiments.

In an embodiment, the engagement surface of the metallic body seat is located radially-inward from a recessed portion of the engagement surface.
In an embodiment, the engagement surface of the metallic body seat extends continuously around the body seat.
In an embodiment, the metallic body seat is removable from the housing.
In an embodiment, the metallic body seat includes a sealing element located between the seal ring and the housing.
In an embodiment, the sealing element includes an o-ring.
In an embodiment, the engagement surface of the metallic body seat includes a metallic o-ring structure.
In an embodiment, the flexible disc seat comprises rubber.
In an embodiment, the flexible disc seat is located within a seat cavity.

In an embodiment, the seat cavity includes a recess for receiving a deformed disc seat during sealing.
In an embodiment, the seat cavity includes a recess for retaining the disc seat.
In an embodiment, the flexible disc seat is held in place by a retaining ring.
In an embodiment, the seat cavity can include a hard stop on the disc configured for contact by the metallic body seat at higher pressures when the flexible disc seat compresses beyond the stopping point provided by the disc seat.
In an embodiment, a swing check valve, the swing check valve is included having a housing, a disc, and a sealing arrangement between the housing and disc, the sealing arrangement is included having a disc seat, and a metallic body seat, wherein the metallic body seat includes an engagement surface for engaging the disc seat, the engagement surface can include a first portion for engaging a flexible elastomeric portion of the disc seat and a second portion for engaging a metallic portion of the disc seat after compressing the flexible elastomeric portion.
In an embodiment, the engagement surface of the metallic body seat extends continuously around the body seat.
In an embodiment, the metallic body seat is removable from the housing.
In an embodiment, the metallic body seat includes a sealing element located between the seal ring and the housing.
In an embodiment, the sealing element includes an o-ring.
In an embodiment, the engagement surface of the metallic body seat includes a metallic o-ring structure.
In an embodiment, the flexible disc seat includes rubber.
In an embodiment, the flexible disc seat is located within a seat cavity.

In an embodiment, the seat cavity includes a recess for receiving a deformed disc seat during sealing.
In an embodiment, the seat cavity includes a recess for retaining the disc seat.

The above summary of the present invention is not intended to describe each discussed embodiment of the present invention. This is the purpose of the figures and the detailed description that follow.

### FIGURES

The invention may be more completely understood in consideration of the following detailed description of various embodiments of the invention in connection with the accompanying drawings in which:

FIG. 1 is a perspective view of a swing check valve made in accordance with an implementation of the invention.

FIG. 2 is cross-sectional side view of a swing check in accordance with an implementation of the invention.

FIG. 3 is an enlarged cross-sectional side view of Detail A from FIG. 2 of a swing check valve made in accordance with an implementation of the invention.

FIG. 4 is a first side view of a swing check valve made in accordance with an implementation of the invention.

FIG. 5 is a second side view of a swing check valve made in accordance with an implementation of the invention.

FIG. 6 is a first end view of a swing check valve made in accordance with an implementation of the invention.

FIG. 7 is a second end view of a swing check valve made in accordance with an implementation of the invention.

FIG. 8 is a bottom view of a swing check valve made in accordance with an implementation of the invention.

FIG. 9 is a top view of a swing check valve made in accordance with an implementation of the invention.

FIG. 10 is a detailed view of portions of a swing check valve and sealing arrangement for the swing check valve, showing initial contact of the sealing surfaces, in accordance with an implementation of the invention.

FIG. 11 is a detailed view of portions of a swing check valve and sealing arrangement for the swing check valve, before engagement of the seal, in accordance with an implementation of the invention.

FIG. 12 is a detailed view of portions of a swing check valve and sealing arrangement for the swing check valve, showing further engagement of the sealing surfaces, in accordance with an implementation of the invention.

FIG. 13 is a detailed view of portions of a swing check valve and sealing arrangement for the swing check valve, showing engagement of the hard stop, in accordance with an implementation of the invention.

The invention will now be understood by review of the following detailed description.

### DETAILED DESCRIPTION

The present application is directed to a swing check valve, the swing check valve comprising a housing; a disc; and a sealing arrangement between the housing and disc. The sealing arrangement comprises a flexible disc seat and a metallic body seat; wherein the metallic body seat comprises an engagement surface for engaging the flexible disc seat, the engagement surface comprising a raised portion for engaging the flexible disc. In an embodiment the metallic body seat comprises an engagement surface for engaging the disc seat, the engagement surface comprising a first portion for engaging a flexible elastomeric portion of the disc seat and a second portion for engaging a metallic portion of the disc seat after compressing the flexible elastomeric portion.

In an embodiment, the swing check valve has a housing, a disc, and a sealing arrangement between the housing and disc, the sealing arrangement is included having a flexible disc seat, and a metallic body seat, wherein the metallic body seat includes an engagement surface for engaging the flexible disc seat, the engagement surface including a raised portion for engaging the flexible disc seat.

In an embodiment, the engagement surface of the metallic body seat is located radially-inward from a recessed portion of the engagement surface. In an alternative embodiment, the engagement surface of the metallic body seat is located radially-outward from a recessed portion of the engagement surface.

In an embodiment, the engagement surface of the metallic body seat extends continuously around the body seat.

In an embodiment, the metallic body seat is removable from the housing.

In an embodiment, the metallic body seat includes a sealing element located between the seal ring and the housing.

In an embodiment, the sealing element includes an o-ring.

In an embodiment, the engagement surface of the metallic body seat includes a metallic o-ring structure.

In an embodiment, the flexible disc seat includes rubber.

In an embodiment, the flexible disc seat is located within a seat cavity.

In an embodiment, the seat cavity includes a recess for receiving a deformed disc seat during sealing.

In an embodiment, the seat cavity includes a recess for retaining the disc seat.

In an embodiment, the flexible disc seat is held in place by a retaining ring.

In an embodiment, further can include a hard stop on the disc configured for contact by the metallic body seat at higher pressures when the flexible disc seat compresses beyond the stopping point provided by the disc seat.

The seal can be formed, for example acrylonitrile-butadiene (NBR) or a terpolymer of ethylene, propylene and a diene (EPDM)

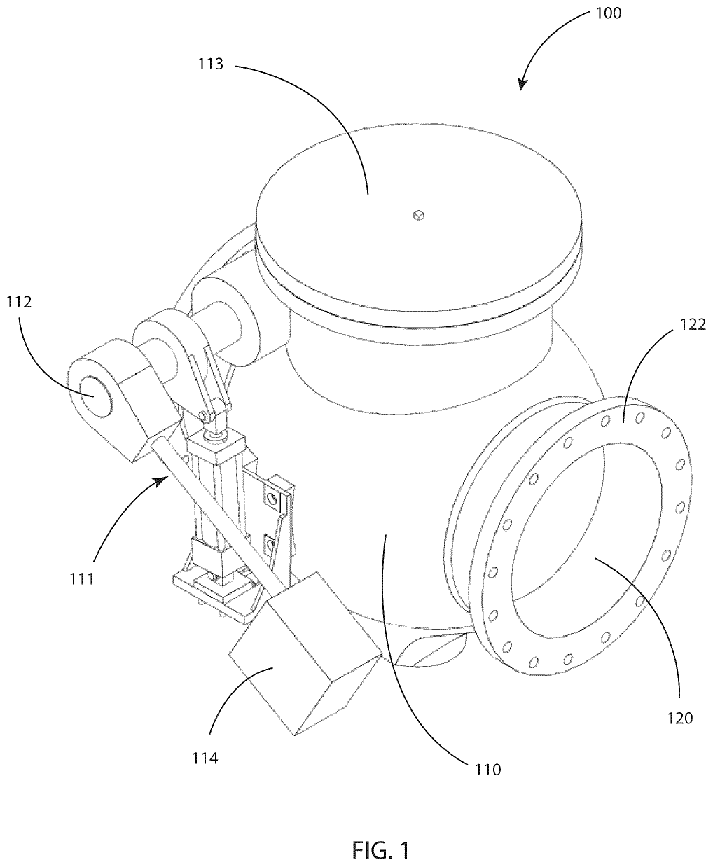

Now in reference to the figures, FIG. 1 is a perspective view of a swing check valve 100 made in accordance with an implementation of the invention. The swing check valve 100 includes a body 110 and an outlet and inlet. In the construction shown in FIG. 1, only the outlet 120 is readily apparent, including a flange 122 surrounding the outlet 120. Flange 122 allows the valve to be mounted in place, such as along a pipeline. Generally, the inlet (opposite the outlet) will also have a flange or other means to join to a pipe or other hardware. The body 110 is generally formed of heavy ductile iron (although other metals can be used). Also, as shown in FIG. 1, a removable cover 113 is often present for servicing the interior valve.

In the depicted embodiment a closure device 111 is shown, including a lever and weight 114 that revolves around a shaft 112. Shaft 112 connects to the interior of the swing check valve 100, where it can engage the disc (not shown) to assist in moving the disc to a closed position. Alternative closure devices can be used. Various closure devices include an air cushion using a side mounted cylinder with lever and weight, a lever and weight (as shown), or a lever and spring.

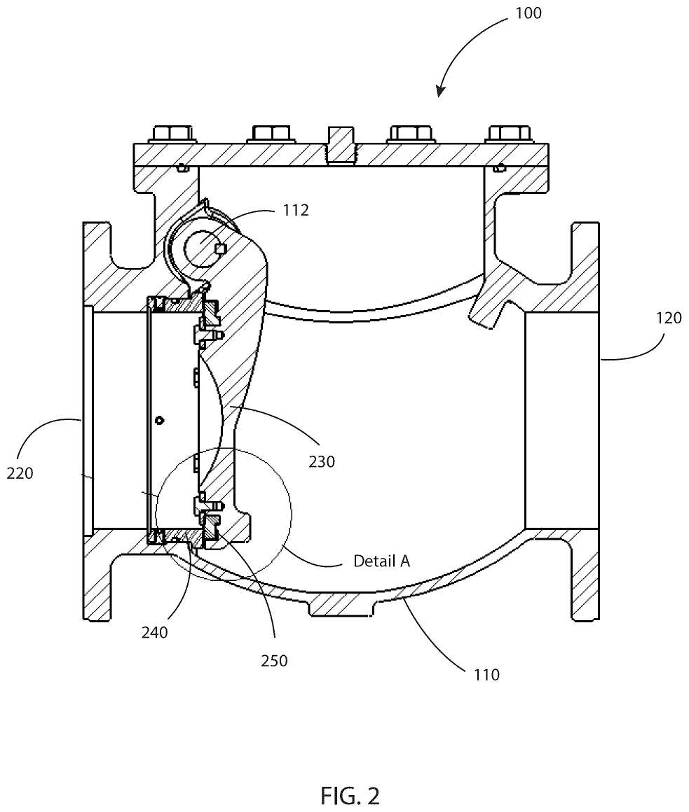

FIG. 2 is cross-sectional side view of a swing check valve 100 made in accordance with an implementation of the invention. FIG. 2 shows the valve having an inlet 220 and an outlet 120. Disc 230 is positioned within the interior of the body 110, and is able to rotate along the axis formed by shaft 112. When fluid is flowing through swing check valve 100 from the inlet 220 to the outlet 120 (left to right in the figure), the disc 230 can rotate out of the way to allow fluid to readily pass through the valve. However, when fluid flow stops or reverses, disc 230 will rotate down (clockwise) to close the valve and prevent flow of fluids out the inlet 220. In the embodiment shown in FIG. 2 disc 230 has rotated down into the closed position.

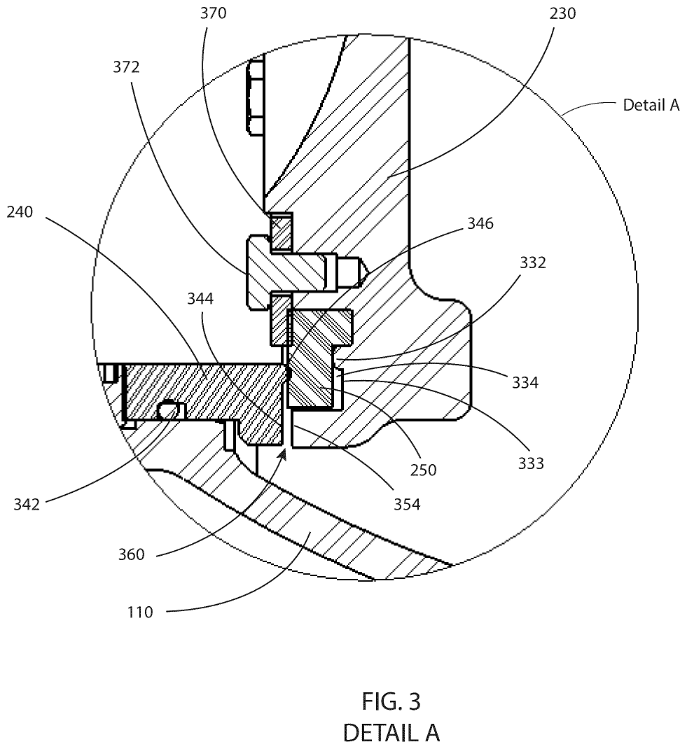

It is desirable that disc 230 form a water-tight seal with the body 110 so that there is no (or minimal) leakage of fluids past the disc when it is a closed position. In the embodiment shown, body 110 includes a metallic body seat 240, and the disc 230 includes a flexible disc seat 250 that engages the metallic body seat 240. The metallic body seat 240 and flexible disc seat 250 engage one another to provide a sealing arrangement that prevents flow of liquids past the disc 230 when in a closed position. The construction is described in more depth below, including with Detail A reproduced in FIG. 3.

FIG. 3 is an enlarged cross-sectional side view of Detail A from FIG. 2, showing the body 110 and the disc 230. In addition, the metallic body seat 240 is shown, as is a flexible disc seat 250. The metallic body seat 240 is generally a metallic ring that is mounted to the interior of body 110. Examples of materials for forming metallic body seats include stainless steel.

The metallic body seat 240 includes surfaces configured to engage the disc 230. In particular, the metallic body seat 240 includes a protrusion 346 (also referenced as a “metallic o-ring”) that extends from a stop surface 344. The disc 230 includes the flexible disc seat 250, which is typically formed of a rubber or other flexible/elastomeric sealing material. The flexible disc seat 250 is arranged along the perimeter of the disc 230 and aligns with the protrusion 346 on the metallic body seat 240. When the disc 230 swings into place the protrusion 346 of the metallic body seat 240 makes contact with the flexible disc seat 250, as shown in FIG. 3, thereby forming a seal along the perimeter of the disc 230.

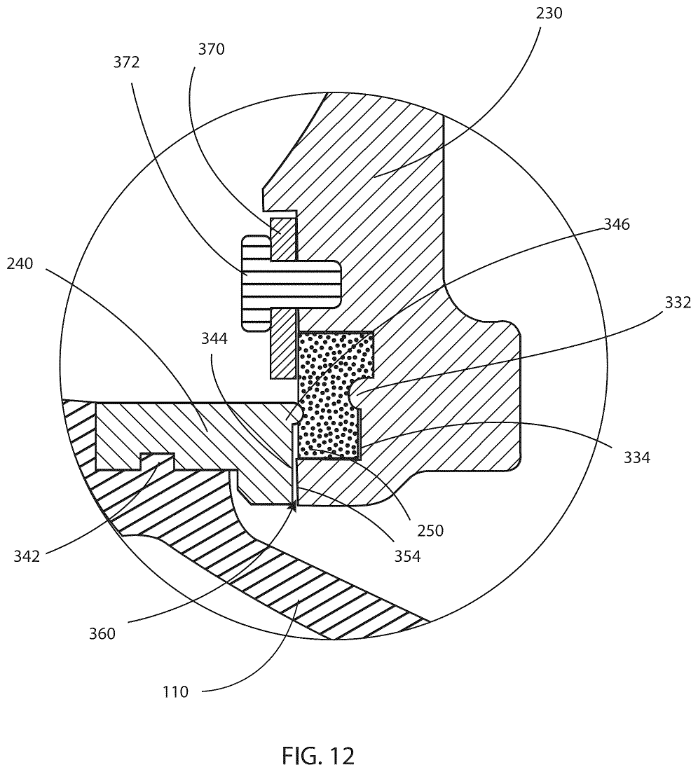

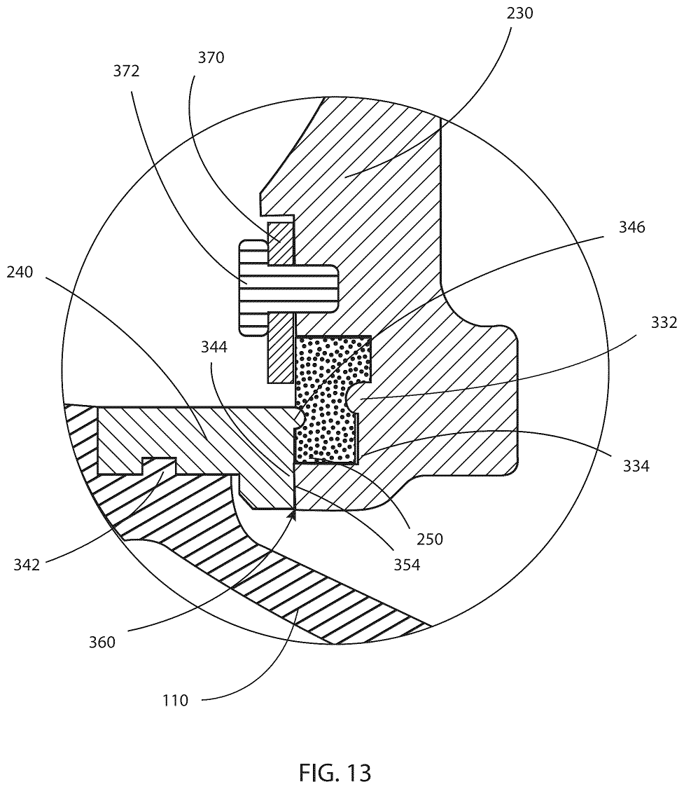

As shown in FIG. 3 (and discussed later in this application), there is a gap 360 that forms between the metallic body seat 240 (in particular stop surface 344) and the outer perimeter of the disc 230, in particular exposed portion 354 of the disc 230. This gap 360 will typically be present when the disc is under limited (or low) back pressure. However, when the back pressure against the disc 230 is high, the flexible disc seat 250 will press against the protrusion 346 sufficiently that the gap 360 will close and there will be direct contact between the stop surface 344 of the metallic body seat 240 and the exposed portion 354 of the disc 230, thereby stopping further closing of the disc 230. Thus, in this secondary position the primary force between disc 230 and body 110 is applied between stop surface 344 of the metallic body seat 240 and the exposed portion 354 of the disc 230. This design allows for the metallic body seat 240 and the exposed portion 354 of the disc 230 to make firm contact and bear the load of even very high pressures because there is a metal-on-metal contact. This limits the pressure applied to the flexible disc seat 250 so that it lasts longer, and good seal can still be made. However, the flexible disc seat 250 can still make contact with the protrusion 346 on the metallic body seat 240 (as will be shown in FIGS. 12 and 13 below).

A further aspect of the design shown in FIG. 3 is a seat cavity 333 into which the flexible disc seat 250 is positioned. Typically, the seat cavity 333 is slightly oversized in one portion, such that there is a gap 334 along a portion of the flexible disc seat 250 allowing the flexible disc seat 250 to press into the gap 334, under some circumstances, such as when the disc 230 is misaligned.

The seat cavity 333 can include a raised portion (or protrusion) 332 that engages the disc seat 250, the raised portion 332 is also similar to an “o-ring” by pressing into the flexible disc seat 250. This localized pressure allows for improved sealing between the disc 230 and the disc seat 250.

Also shown in FIG. 3 is a seat retaining ring 370 held in place by retaining ring screws 372. The retaining ring 370 (which is sometimes one continuous ring, or alternatively segments of a ring) maintains the position of the disc seat 250. To remove the disc seat 250 it is typically necessary to remove the retaining ring 370 by removing the retaining ring screws 372.

Also shown in FIG. 3 is an o-ring 342 located in a slot in the metallic body seat 240. The o-ring provides a improved seal between the metallic body seat 240 and the body 110. Generally, the metallic body seat 240 will fit into a machined annular surface on the body 110, but the o-ring 342 provides improved sealing to prevent leaking. Thus, the body 110 has a sealing connection with the metallic body seat 240, the metallic body seat 240 forms a fluid-tight seal with the disc seat 250 that can dynamically engage under various pressures, and the disc seat 250 itself is in a sealing connection with the disc. The result of the construction as shown is one in which a strong seal can be made even under either high or low loading forces, and one which provides a durable seal whether the loading forces from the back flow are high or low over long or short periods of time.

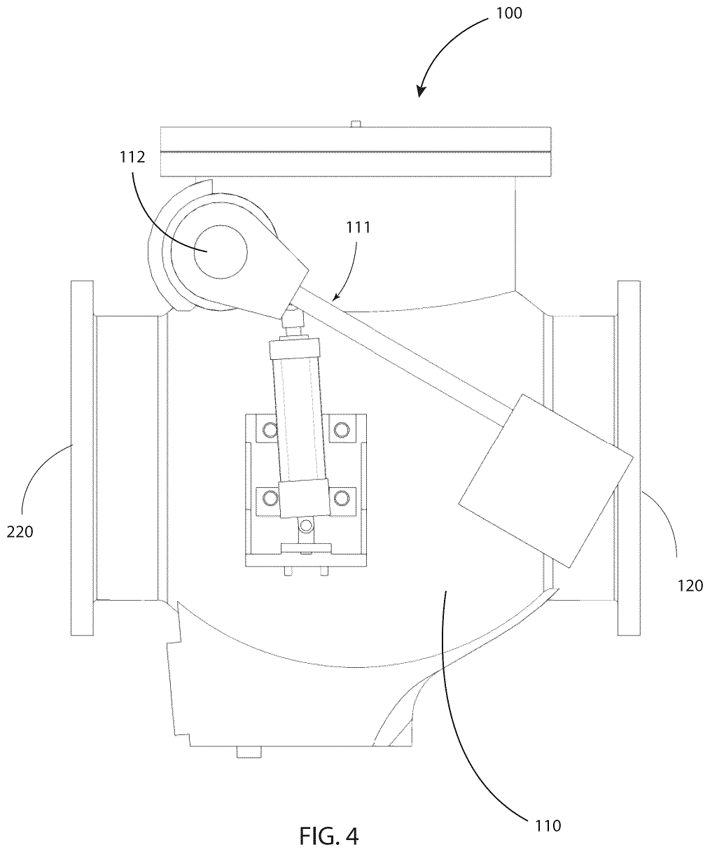

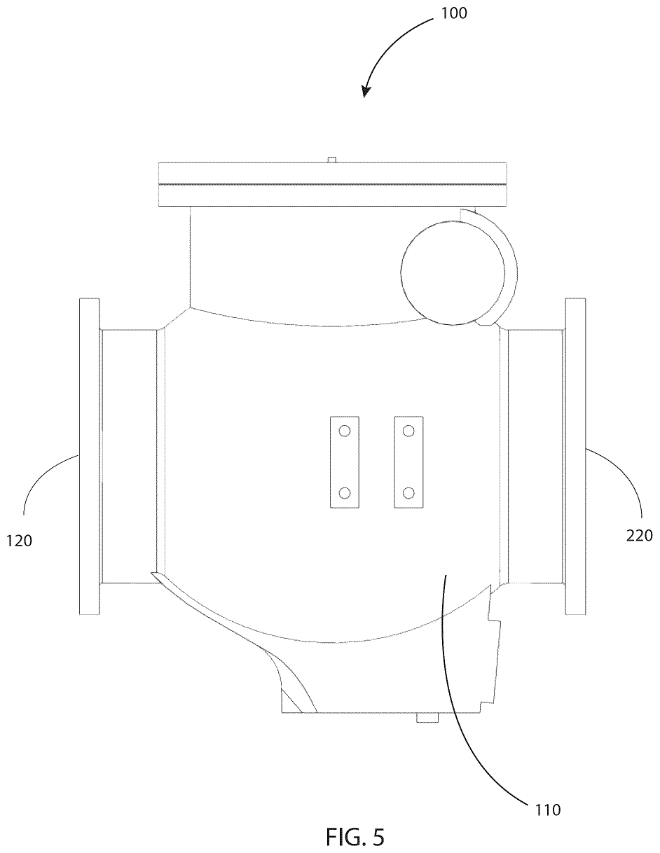

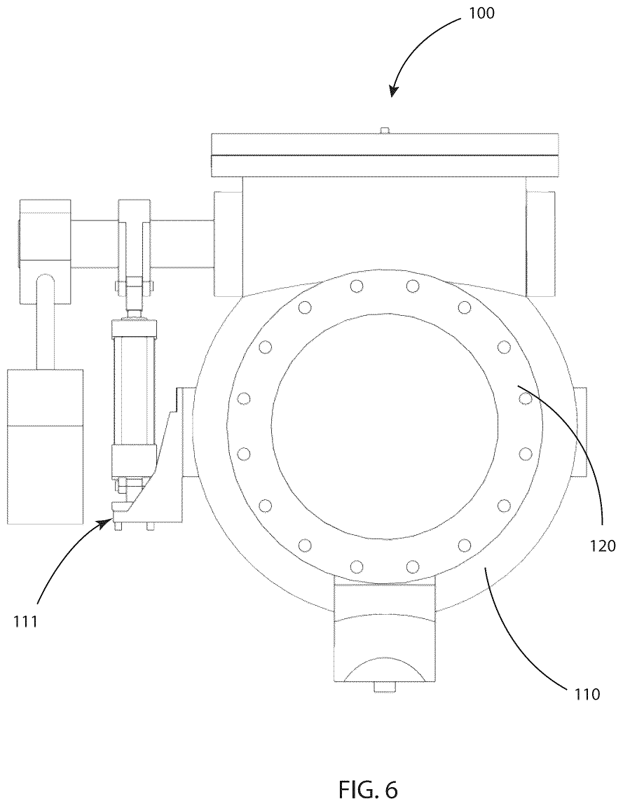

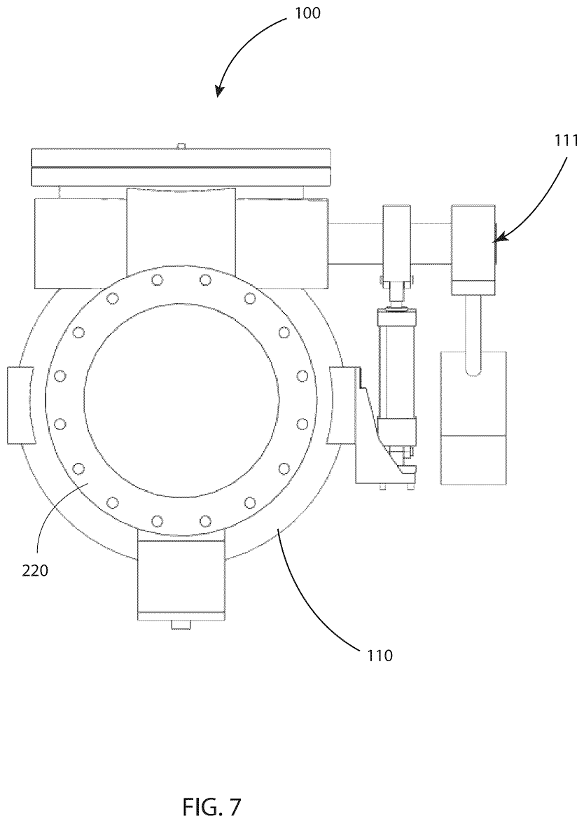

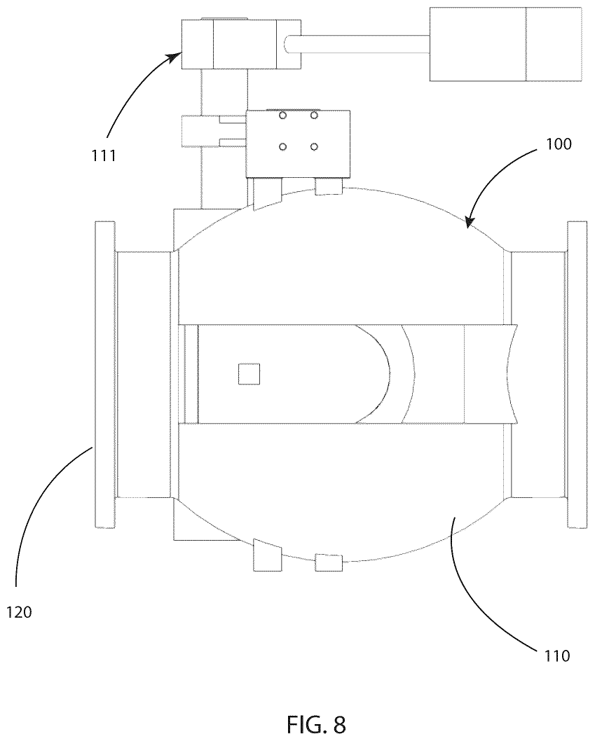

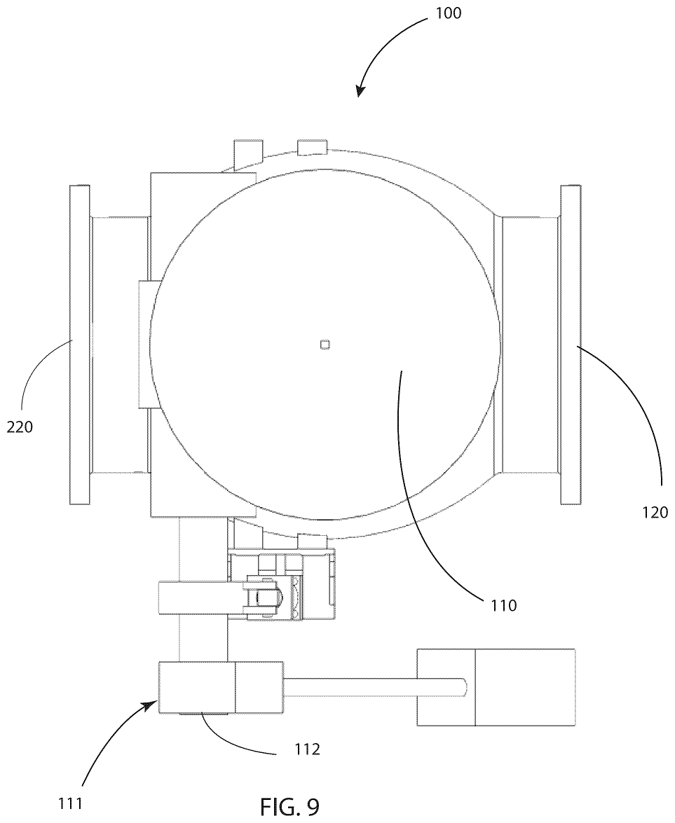

FIGS. 4 to 9 show various views of an example swing check valve. It will be appreciated that these views are primarily to show example constructions, but they can be varied as desired based upon end uses, such as the size of required openings, etc. FIG. 4 is a first side view of a swing check valve 100 made in accordance with an implementation of the invention. FIG. 5 is a second first side view of a swing check valve 100 made in accordance with an implementation of the invention. FIG. 6 is a first end view of a swing check valve 100 made in accordance with an implementation of the invention. FIG. 7 is a second end view of a swing check valve 100 made in accordance with an implementation of the invention. FIG. 8 is a bottom view of a swing check valve made in accordance with an implementation of the invention. FIG. 9 is a top view of a swing check valve 100 made in accordance with an implementation of the invention.

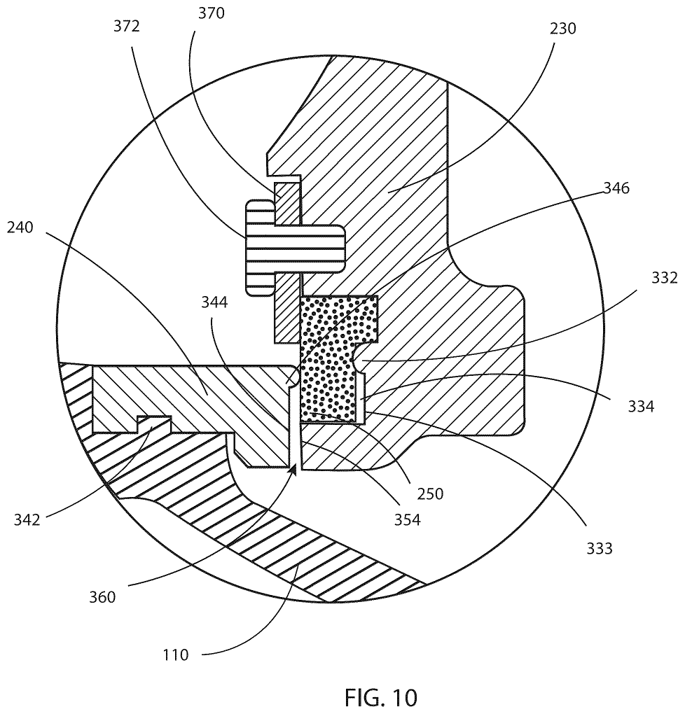

Now referring to FIGS. 10 to 13, FIG. 10 is a detailed view of portions of a swing check valve 100 sealing arrangement for the swing check valve, showing initial contact of the sealing surfaces, in accordance with an implementation of the invention. The metallic body seat 240 is shown, as is a flexible disc seat 250. The metallic body seat 240 is generally a metallic ring that is mounted to the interior of body 110. Examples of materials for forming metallic body seats include stainless steel.

The metallic body seat 240 includes surfaces configured to engage the disc 230. In particular, the metallic body seat 240 includes a protrusion 346 (also referenced as a “metallic o-ring”) that extends from a stop surface 344. The disc 230 includes the flexible disc seat 250, which is typically formed of a rubber or other flexible/elastomeric sealing material. The flexible disc seat 250 is arranged along the perimeter of disc 230 and aligns with the protrusion 346 on the metallic body seat 240. When the disc 230 swings into place the protrusion 346 of the metallic body seat 240 makes contact with the flexible disc seat 250, as shown in FIG. 10, thereby forming a seal along the perimeter of the disc 230.

A gap 360 is formed between the metallic body seat 240 (in particular stop surface 344) and the outer perimeter of the disc 230, in particular exposed portion 354 of the disc 230. This gap 360 will typically be present when the disc is under limited (or low) back pressure as shown in FIG. 10. However, when the back pressure against the disc 230 is high, the flexible disc seat 250 will press against the protrusion 346 sufficiently that the gap 360 will close and there will be direct contact between the stop surface 344 of the metallic body seat 240 and the exposed portion 354 of the disc 230, thereby stopping further closing of the disc 230.

A further aspect of the design shown in FIG. 10 is a seat cavity 333 into which the flexible disc seat 250 is positioned. Typically, the seat cavity 333 is slightly oversized in one portion, such that there is a gap 334 along a portion of the flexible disc seat 250 allowing the flexible disc seat 250 to press into the gap 334, under some circumstances, such as when the disc 230 is misaligned.

The seat cavity 333 can include a raised portion (or protrusion) 332 that engages the disc seat 250, the raised portion 332 is also similar to an “o-ring” by pressing into the flexible disc seat 250. This localized pressure allows for improved sealing between the disc 230 and the disc seat 250.

A seat retaining ring 370 held in place by retaining ring screws 372. The retaining ring 370 (which is sometimes one continuous ring, or alternatively segments of a ring) maintains the position of the disc seat 250. To remove the disc seat 250 it is typically necessary to remove the retaining ring 370 by removing the retaining ring screws 372. An o-ring 342 is located in a slot in metallic body seat 240. The O-ring provides a improved seal between the metallic body seat 240 and the body 110. Generally, the metallic body seat 240 will fit into a machined annular surface on the body 110, but the o-ring 342 provides improved sealing to prevent leaking. Thus, the body 110 has a sealing connection with the metallic body seat 240, the metallic body seat 240 forms a fluid-tight seal with the disc seat 250 that can dynamically engage under various pressures, and the disc seat 250 itself is in a sealing connection with the disc. The result of the construction as shown is one in which a strong seal can be made even under either high or low loading forces, and one which provides a durable seal whether the loading forces from the back flow are high or low over long or short periods of time.

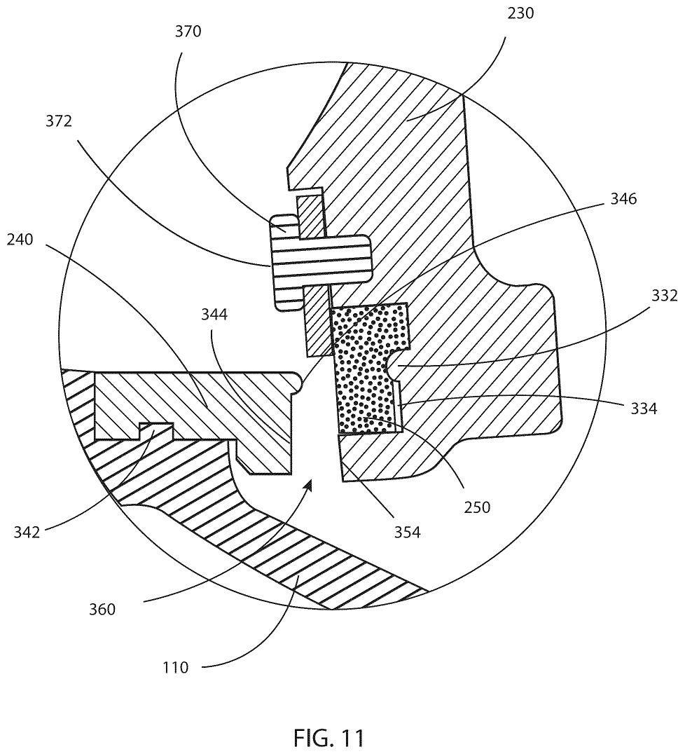

FIG. 11 is a detailed view of portions of a swing check valve 100 and sealing arrangement for the swing check valve, before engagement of the seal upon closing (or just after the disc 230 is opening), in accordance with an implementation of the invention. A relatively large gap 360 is present between the metallic body seat 240 and the disc seat 250. Typically, the position of the components in FIG. 11 will be as the valve seals or as the valve opens. Thus, FIG. 11 is essentially a position that will normally be temporarily maintained before or after the position of FIG. 10 (for example).

FIG. 12 is a detailed view of portions of a swing check valve 100 and sealing arrangement for the swing check valve 100, showing further engagement of the sealing surfaces, in accordance with an implementation of the invention. FIG. 12 the valve is more tightly closed than it was in FIG. 10, as evidenced by the protrusion 346 on the metallic body seat 240 compressing more deeply into disc seat 250.

FIG. 13 is a detailed view of portions of a swing check valve 100 and sealing arrangement for the swing check valve, showing initial engagement of the hard stop, in accordance with an implementation of the invention. In this position the primary force between disc 230 and body 110 is applied between stop surface 344 of the metallic body seat 240 and the exposed portion 354 of the disc 230. This design allows for the metallic body seat 240 and the exposed portion 354 of the disc 230 to make firm contact and bear the load of even very high pressures because there is a metal-on-metal contact. This limits the pressure applied to the flexible disc seat 250 so that it lasts longer and good seal can still be made. However, the flexible disc seat 250 can still make contact with the protrusion 346 on the metallic body seat 240.

The present invention should not be considered limited to the particular examples described above but rather should be understood to cover all aspects of the invention as fairly set out in the attached claims. Various modifications equivalent processes as well as numerous structures to which the present invention may be applicable will be readily apparent to those of skill in the art to which the present invention is directed upon review of the instant specification.

1. A swing check valve, the swing check valve comprising:
a housing;
a disc; and
a sealing arrangement between the housing and disc, the sealing arrangement comprising:
a flexible disc seat; and
a metallic body seat;
wherein the metallic body seat comprises an engagement surface for engaging the flexible disc seat, the engagement surface comprising a raised portion for engaging the flexible disc seat.

2. The swing check valve of claim 1, wherein the engagement surface of the metallic body seat is located radially-inward from a recessed portion of the engagement surface.

3. The swing check valve of claim 1, wherein the engagement surface of the metallic body seat extends continuously around the body seat.

4. The swing check valve of claim 1, wherein the metallic body seat is removable from the housing.

5. The swing check valve of claim 1, wherein the engagement surface of the metallic body seat comprises a metallic o-ring structure.

6. The swing check valve of claim 1, wherein the flexible disc seat comprises rubber.

7. The swing check valve of claim 1, wherein the flexible disc seat is located within a seat cavity.

8. The swing check valve of claim 7, wherein the seat cavity comprises a recess for receiving a deformed disc seat during sealing.

9. The swing check valve of claim 8, wherein the seat cavity includes a recess for retaining the disc seat.

10. The swing check valve of claim 7, wherein the flexible disc seat is held in place by a retaining ring.

11. The swing check valve of claim 1, further comprising a hard stop on the disc configured for contact by the metallic body seat at higher pressures when the flexible disc seat compresses beyond the stopping point provided by the disc seat.

12. A swing check valve, the swing check valve comprising:
a housing;
a disc; and
a sealing arrangement between the housing and disc, the sealing arrangement comprising:
a disc seat; and
a metallic body seat;
wherein the metallic body seat comprises an engagement surface for engaging the disc seat, the engagement surface comprising a first portion for engaging a flexible elastomeric portion of the disc seat and a second portion for engaging a metallic portion of the disc seat after compressing the flexible elastomeric portion.

13. The swing check valve of claim 12, wherein the engagement surface of the metallic body seat extends continuously around the body seat.

14. The swing check valve of claim 12, wherein the metallic body seat is removable from the housing.

15. The swing check valve of claim 12, wherein the metallic body seat comprises a sealing element located between the seal ring and the housing.

16. The swing check valve of claim 12, wherein the engagement surface of the metallic body seat comprises a metallic o-ring structure.

17. The swing check valve of claim 12, wherein the flexible disc seat comprises rubber.

18. The swing check valve of claim 12, wherein the flexible disc seat is located within a seat cavity.

19. The swing check valve of claim 18, wherein the seat cavity comprises a recess for receiving a deformed disc seat during scaling.

20. The swing check valve of claim 18, wherein the seat cavity includes a recess for retaining the disc seat.
